(19) United States
(12) Patent Application Publication
(10) Pub. No.: US 2005/0077021 A1
(43) Pub. Date: Apr. 14, 2005

(54) Method for producing paper imprinted with a pattern

(76) Inventors: Ernst Brunbauer, Traun (AT); Berndt Koll, Gmunden (AT); Markus Eibl, Wels (AT); Andreas Windischbauer, Traun (AT)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/501,894

(22) PCT Filed: Apr. 24, 2002
(86) PCT No.: PCT/AT02/00125

(30) Foreign Application Priority Data
Feb. 1, 2002 (AT) A 174/2002

(51) Int. Cl. B41M 1/00; A24D 1/10

(52) U.S. Cl. 162/139; 162/134; 162/204; 162/135; 162/158; 162/175; 162/168.1

(57) ABSTRACT

The invention relates to a method for producing paper imprinted with a pattern, especially cigarette paper that is impregnated stripwise with fire-retardant materials. According to said method, a self-supporting web of paper is imprinted with an aqueous printing solution. Said printing solution contains water-soluble polymers and the paper is heated to above 50° C. before or during printing.

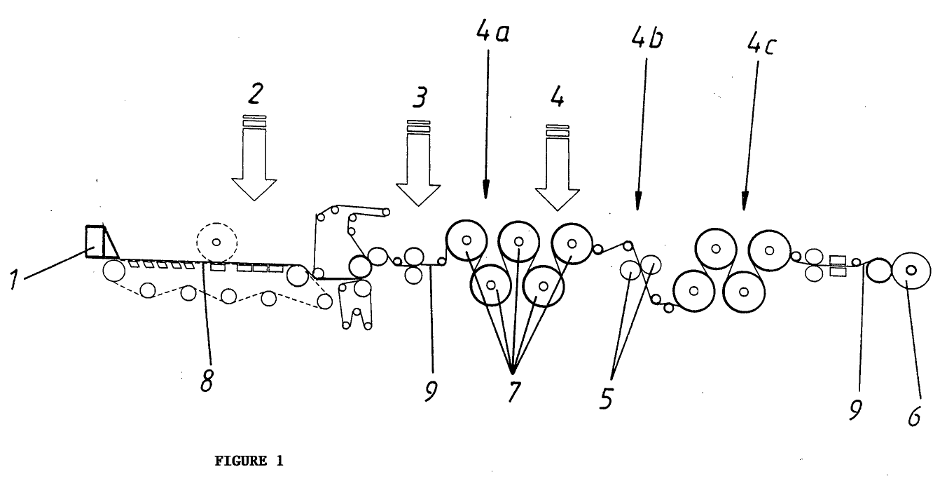

Process for the production of paper printed upon in pattern form The invention relates to a process for the production of paper printed upon in pattern form, in particular cigarette paper which is impregnated in strip form with fire-inhibiting materials, wherein printing is effected with an aqueous printing solution on a self-supporting paper web.

The term aqueous printing solution is used to denote a solution of a polymer in water. In addition the printing solution may contain organic and inorganic pigments, dyestuffs and salts.

It has long been known that annular bands which extend around a cigarette have a fire-inhibiting action, in particular if the permeability of the cigarette wrapping enclosure is reduced in that region. For example U.S. Pat. No. 1,555,320 dating from the year 1923 puts forward the proposal of making such a band in the form of an integral part of the cigarette paper. A corresponding process is known for example from EP 0 486 213 B1 disclosing the production of fire-inhibiting transverse ribs on the screen of a paper making machine by an increased application of fiber slurry or fillers. In that process the application operation is effected during a process step in which the paper web is not yet self-supporting and cannot yet be subjected to a free tensile force. It is only after the pressing part that the paper web is subjected to the first free tensile effect.

Alternatively, processes of the kind set forth in the opening part of this specification are known, for example from U.S. Pat. No. 1,996,002. Here there now arises the problem that difficulties are encountered in printing the strips with an adequate degree of edge sharpness. A determining criterion in terms of the quality of the printing on paper is edge sharpness. Particularly when printing using aqueous solutions, the printing solution suffers from a bleeding-out effect in the edge region, whereby the boundary between a printed and an unprinted region becomes blurred. In order to prevent the printing solution from running on the paper, coated or treated papers are usually employed. Uncoated or untreated papers result in contours which are not sharp, when using aqueous printing solutions. Therefore those papers are frequently printed upon using organic solvents, such as for example ethyl acetate or ethanol. Those solvents have to be sucked away and disposed of or cleaned up. In addition there is always the risk of catching fire when using organic solvents.

An improvement in edge sharpness when producing printing using aqueous solutions can also be implemented by increasing the viscosity of the printing solution. A proposal to that effect is known from U.S. Pat. No. 4,077,414. High-viscosity printing solutions are referred to as printing pastes. However printing pastes cannot be used in the intaglio printing process. When screen printing processes are involved, the possible printing speed decreases greatly with the increase in the viscosity of the printing solution.

For certain uses, for example cigarette paper, a good absorption capability on the part of the paper is necessary. Therefore those papers cannot be treated or coated. The higher the absorption capability of the paper however, the correspondingly greater is the degree of bleeding of the printing ink and the correspondingly worse is the edge sharpness of the printed image. A measurement in respect of absorption characteristics is the absorption height in mm/10 min in accordance with DIN 53106:1981.

In order to print upon in particular untreated, uncoated, absorbent papers even at a high printing speed (for example >70 m/min, in particular 100-300 m/min) with at the same time a high degree of edge sharpness, it is provided in accordance with the invention that the printing solution contains water-soluble polymers and the paper is heated to over 50° C. prior to or during the printing operation.

The rapid evaporation of the water from the printed area then prevents the printing solution from bleeding out in the edge regions, and the result obtained is a sharp-edged printed image even on untreated, uncoated, absorbent paper. The viscosity of the printing solution can be kept at a low value. That makes it possible to employ printing speeds of >70 m/min. Preheating of the paper can be effected by a contact heating means, for example a cylinder, or also by a radiant heating means such as for example an infrared radiating device or also by other electromagnetic waves, such as for example microwaves.

The printing processes used can be both intaglio, digital (inkjet) or screen printing in the usual forms corresponding to the state of the art. A preferred form is rotary screen printing.

### EXAMPLES

Printing is implemented on an untreated, uncoated paper of cellulose and inorganic filler with a base weight of 26 g/m² and an absorption height of 9 mm/10 min with an aqueous solution of methyl cellulose (cloud point at 70° C.) and Solophenyl Blue GL, by means of intaglio printing. The viscosity of the printing solution is 90 mPa s. The design of the printing cylinder has stripes parallel to the axis of rotation. The printing speed is 150 m/min. The paper is preheated to various temperatures by means of a heatable cylinder upstream of the printing mechanism.

| Paper temperature prior to printing | Printed image |
|---|---|
| Without preheating, 25° C. | non-sharp, band width fluctuates |
| | over the printed width, lesser color |
| | depth in the edge zone, compared |
| | to the middle of the stripe. |
| Preheating to 75° C. | sharp, uniformly colored bands over |
| | the entire width |

An untreated uncoated paper of a base weight of 32 g/m² and an absorption height of 12 mm/10 min is printed upon by means of rotary screen printing with a solution of 150/% polyvinyl alcohol and Solophenyl Blue GL. The viscosity of the printing solution is 18 mPa s. The stencil has bands parallel to the axis of rotation, of a width of 7 mm and at a spacing of 18.6 mm. Preheating of the paper is effected by means of a heatable cylinder and an infrared radiator.

| Paper temperature prior to printing | Printed image |
|---|---|
| Without preheating, 30° C. | non-sharp, band width fluctuates |
| | over the printed width, lesser color |
| | depth in the edge zone, compared |
| | to the middle of the stripe. |
| Preheating to 90° C. | sharp, uniformly colored bands over |
| | the entire width |

An untreated uncoated paper of a base weight of 38 g/m² and an absorption height of 14 mm/10 min is printed upon by means of rotary screen printing with a solution of 60/% methylhydroxypropyl cellulose with a cloud point of about 60° C. and Solophenyl Blue GL. The stencil has bands of a width of 7 mm. Preheating of the paper is effected by means of a heatable cylinder and a heatable pressing device. The moisture content of the paper upstream of the printing mechanism is 40%.

| Paper temperature prior to printing | Printed image |
|---|---|
| Without preheating, 30° C. | non-sharp, band width fluctuates |
| | over the printed width, lesser color |
| | depth in the edge zone, compared |
| | to the middle of the stripe. |
| Preheating to 80° C. | sharp, uniformly colored bands over |
| | the entire width |

An apparatus on which the invention can preferably be carried into effect is set out hereinafter with reference to the drawing.

The illustrated apparatus is a conventional paper machine with a breastbox 1 and a paper screen 8 through which a mixture of fiber slurry and fillers (dry content below 1%) is sucked away. After leaving the screen portion 2 the paper web 9 is dried in a pressing portion 3 to a dry content of about 40%. Downstream of the pressing portion the paper web 9 is consolidated to such an extent that it can be subjected as a self-supporting web to a free tensile effect. The apparatus then has a drying portion 4 with a series of drying cylinders 7, at the end of which the moisture content is about 2-3%. The invention even functions at moisture levels prior to the printing operation of 2-40%, especially as, when impregnating the paper web in accordance with a pattern, the water content is in any case greatly increased. If the paper is at an adequate temperature, under no circumstances does the printed image suffer from running. Printing of the web 9 can be effected in the region of the drying portion 4a or 4c, in which case one of the heated cylinders 7 forms the printing backing support 4, or in the region 4b, in which case here the use of a heated pressing device affords a further improvement.

The position 4a is preferred as stresses in the paper caused by the printing operation can be reduced by impregnation over the entire surface area in the size press 5. The temperature of the size press must be adapted to the dissolution characteristics of the polymer used. For example, fully hydrolyzed polyvinyl alcohol only dissolves at temperatures of over 90° C., and accordingly the size press must be operated as cold as possible. In the case of polymers with poor dissolution characteristics in the heated condition, the size press is operated hot. Then, the increase in moisture content to about 40%, which occurs due to the impregnation operation, no longer causes movement of the printed image. After further drying the web 9 is wound onto the winding reel 6.

1. A process for the production of paper printed upon in pattern form, in particular cigarette paper which is impregnated in strip form with fire-inhibiting materials, wherein printing is effected with an aqueous printing solution on a self-supporting paper web characterized in that the printing solution contains water-soluble polymers and the paper is heated to over 50° C. prior to or during the printing operation.

2. A process as set forth in claim 1 characterized in that the polymers originate from one or more of the hereinafter listed classes of polyvinyl alcohols, polysaccharides, modified polysaccharides or partially hydrolyzed polyvinyl acetates.

3. A process as set forth in claim 1 or claim 2 characterized in that the temperature is higher than that value at which the polymers precipitate from water.

4. A process as set forth in one of the preceding claims characterized in that the paper is heated to 70-90° C. prior to or during the printing operation.

5. A process as set forth in one of claims 1 through 4 characterized in that the printing solution is of a viscosity of a maximum of 4000 mPa s at 20° C.

6. A process as set forth in one of claims 1 through 5 characterized in that the paper is of a base weight of 15-40 g/m².

7. A process as set forth in one of claims 1 through 6 characterized in that the paper to be printed upon has an absorption height of 6-15 mm/10 min, preferably an absorption height of 8-13 mm/10 min.

8. A process as set forth in one of the preceding claims characterized in that the operation of printing on the paper is effected after it has left the paper screen and the press portion of a paper machine but before the paper web is rolled up.

9. A process as set forth in claim 8 characterized in that the paper web is printed upon, wherein a contact dryer for the paper web, in roller form, serves as a backing support.

10. A process as set forth in claim 9 characterized in that subsequently to the printing operation the paper web is impregnated over its entire surface area with an aqueous solution.

11. A process as set forth in claim 10 characterized in that the aqueous solution contains fire-promoting means.
